(19) United States
(12) Patent Application Publication
(10) Pub. No.: US 2005/0204566 A1
(43) Pub. Date: Sep. 22, 2005

(54) Travel food scissor

(76) Inventor: Denise Loporcaro, Manalapan, NJ (US)

Correspondence Address: Charles I. Brodsky, Esq., 2 Bucks Lane, Marlboro, NJ, 07746, US

(21) Appl. No.: 10/804,774

(22) Filed: Mar. 22, 2004

(51) Int. Cl. B26B 3/06

(52) U.S. Cl. 30/151

(57) ABSTRACT

A food cutting scissor within a releasably openable travel case of dimension to fit within a shirt or blouse pocket, a purse, handbag or pocketbook.

### CROSS-REFERENCE TO RELATED APPLICATIONS

NONE

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the cutting of prepared food for children, in general, and to the away-from-the-home cutting of prepared food for children, in particular.

2. Description of the Related Art

As will well be appreciated, in eating or dining at a restaurant or like facility away from home, a parent almost always cuts his/her child's food first, before starting on their own meal. Where such meal consists of a cold platter, for example, the time spent in cutting the child's food does not substantially impair the parent's subsequent own food enjoyment; on the other hand, where the parent's meal is in the nature of a hot platter, the longer it takes to cut the child's portion into bite-size pieces, the more the parent's meal cools and its enjoyment decreases.

For pre-elementary school children, the tendency nowadays is for more meals to be had in fast food restaurants—where orders are typically of hamburgers, hot dogs, chicken fingers, fries and pizza. In those places—and almost always at children's birthday parties where such food is generally the rule—, the tableware service commonly is of plastic forks and knives for purposes of safety. Everyday experience has shown that not only is it time consuming and frustrating to try to cut these foods with these utensils, but the plastic fork frequently tends to collapse and break under the pressure of trying to hold down the food item while attempting to cut it with the plastic knife. Whether or not the parent intends to join his/her child in eating such food preparations, this type of food cutting leaves much to be desired. While fine restaurants continue to serve with metal tableware, many continue to regularly provide plastic utensils for children's dishes out of a consideration for safety—while those fast food establishments which typically cater to children (e.g., McDonalds, Burger King, Wendy's, Kentucky Fried Chicken, Pizza Hut) almost universally deal with plastic knives and forks.

### SUMMARY OF THE INVENTION

As will become clear from the following description, the present invention deals with this situation by providing a travel food scissor which a parent can take along to any kind of food establishment away from home, to easily cut whatever food is prepared in a safe and sanitary manner. As will be seen, a carry case is provided for the scissors, having a releasably openable closed cover for housing the scissors until needed, and with the carry case being of a size to fit within a shirt or blouse pocket, a purse, handbag or pocketbook. When away from home to cut food prepared for the child, all that needs to be done is to open the cover of the case, remove the scissors, use it to cut the food instead of using the plastic fork and knife provided, and then replace the scissors back into the case for taking home—where the case and scissors could then be cleansed in a dishwasher or in any appropriate manner. In carrying out the intent of the invention for this type of scissors to be carried about, the scissors are selected along with the case so as to have an overall length not to exceed six inches and an overall width not to exceed four inches. In the preferred embodiment of the invention to be described below, the scissors are selected of a stainless steel composition, the case is selected of a plastic composition, and a flip-open cover is employed hinged to the front surface of the cover to allow access of the scissors when needed, and to close the case with the scissors inside after use.

### BRIEF DESCRIPTION OF THE DRAWINGS

These and other features of the present invention will be more clearly understood from a consideration of the following description, taken in connection with the accompanying drawings in which:

FIGS. 1 and 2 are pictorial views helpful in an understanding of the preferred embodiment of the invention;

FIGS. 3 and 4 are pictorial views helpful in an understanding of the hinged nature of the flip-open cover of the carry case;

FIGS. 5 and 6 are sectional views for an understanding of the case of FIGS. 1 and 2; and

FIG. 7 shows a manner of construction of a preferred pair of scissors for use according to the invention.

### DETAILED DESCRIPTION OF THE INVENTION

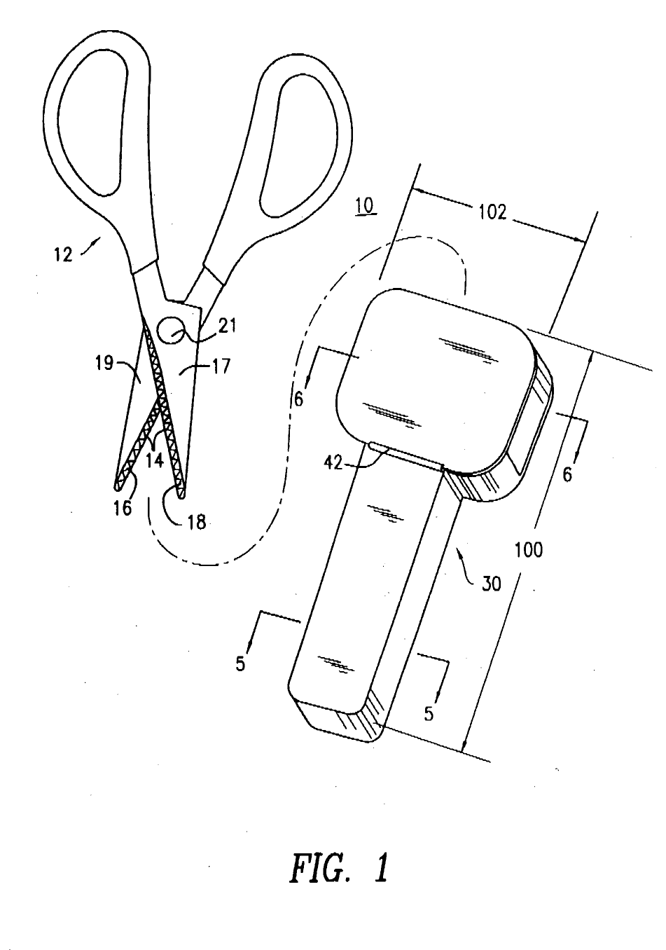

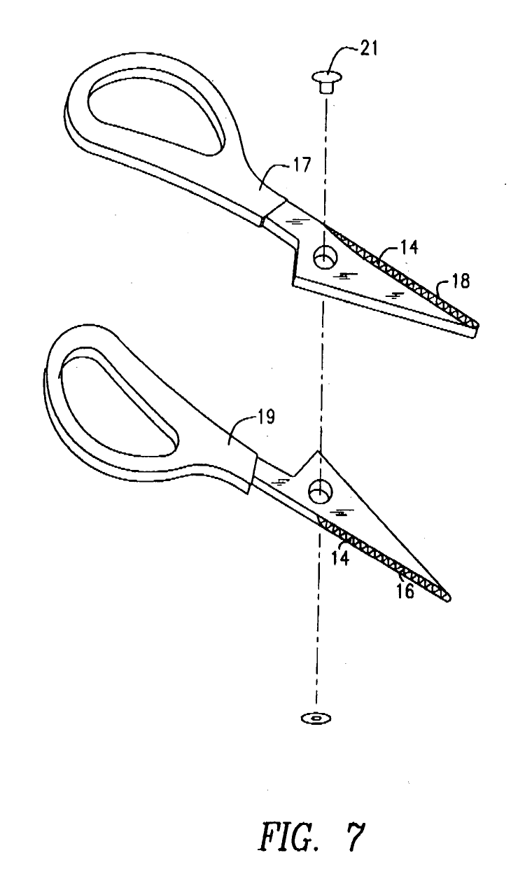

In the Drawings, the travel food scissor 10 includes a pair of scissors 12 having teeth serrations 14 along at least one of the two opposing cutting edges thereof 16, 18. With the two blades of the scissors 17, 19 joined by a rivet 21, the serrations 14 in the preferred embodiment of the invention are provided along both of the cutting edges 16, 18, as more clearly shown in FIG. 7. Composed of stainless steel, for example, the pair of scissors 12 is intended to be insertable within a carry case 30 as shown in FIG. 1.

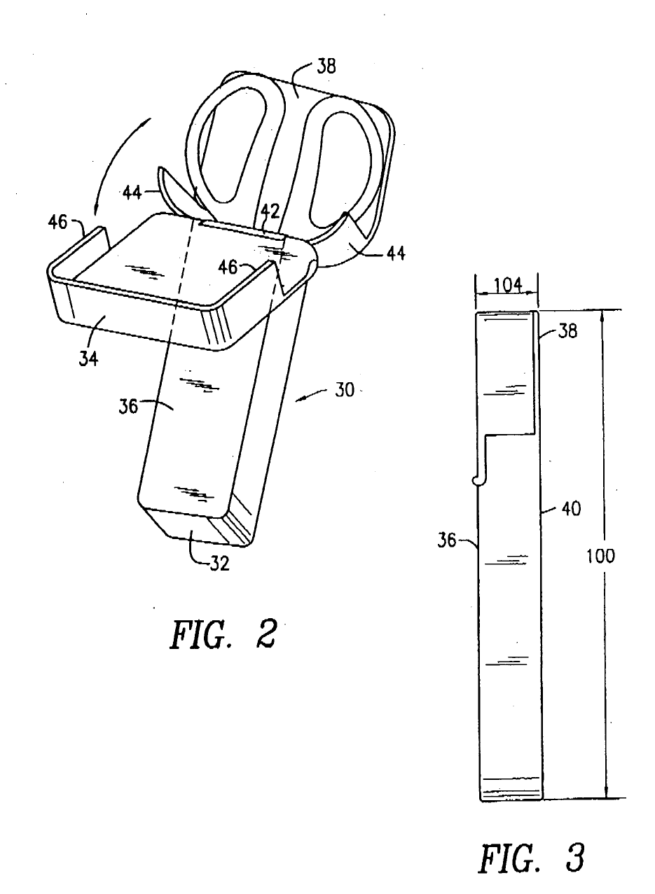

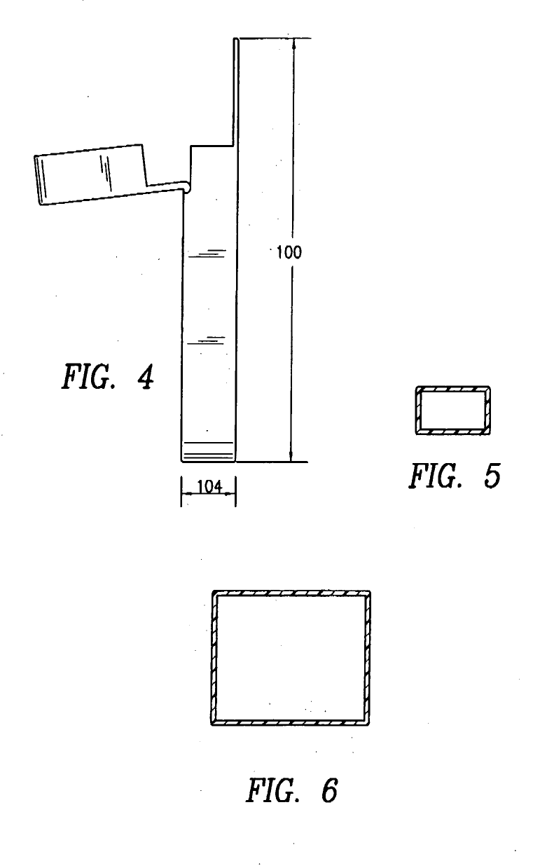

In accordance with the invention, the carry case 30 is selected along with the pair of scissors 12 to be of a size to fit within a shirt or blouse pocket, a purse, handbag or pocketbook so that the combination can be taken along to food establishments, party locations and elsewheres, to be used when needed to cut the child's food safely and quickly. Preferably selected to have a length 100 not in excess of some six inches, a width 102 not in excess of some four inches, and a depth 104 not in excess of some one inch, the carry case 30 can then be carried about easily. Shown in FIG. 2 to be closed at one end 32 and including a flip-open cover 34 at an opposite end, the carry case 30 will be seen as having its cover 34 hinged at the front surface 36 of the case, with the cover 34 overlying an extension 38 of a rear surface 40 of the case, against which the scissors 12 rest. FIGS. 3 and 4 then illustrate the closed position and opened position of the cover 34, respectively, with the hinge being shown at 42. FIGS. 5 and 6, being individual views along the sectional lines 5 and 6 of the case 30 of FIG. 1, illustrate that the closed end 32 of the case 30 is of a narrower width than at the cover end, adjacent extension 38. To hold the cover 34 closed in housing the scissors 12, a first pair of wall surfaces 44 extend upwardly from the extension 38 as an underlying lid of the rear surface 40 to respectively join with a second pair of wall surfaces 46 which extend downwardly from the flip-open cover 34 of the front surface 36. As FIGS. 1 and 2 illustrate, these wall surfaces 44 and 46 may be curved and straight in effecting the join.

With the carry case 30 being of plastic composition, and with the pair of scissors 12 being of stainless steel composition, it becomes then but a simple matter for the parent, when desiring to cut his/her child's prepared food away-from-the-home, to remove the case 30 from the pocket, purse, handbag or pocketbook, flip open the cover 34, reach in and remove the scissors 12 and then snip the hamburger, hot dog, chicken finger, fry or pizza slice to bite size—or cut the crust from a sandwich or a strand of spaghetti for that matter—in a quick and easy manner without having to worry about exceeding the breaking force of a plastic fork, or trying to deal with the dull edges of a plastic knife. Upon completing the needed snipping or cutting to size, the scissors are then merely wiped off, put back into the case, the cover is closed, and the case put back for carrying within the pocket or bag. Upon arriving back at home later on, the scissors and case can be washed or otherwise cleansed in any appropriate manner.

While the advantages offered by the invention will be readily apparent, its benefits will be seen even more in those instances where the parent or parents are away from home on vacation, where the need to cut the child's food is required 3-4-5 times each day. The features offered by the invention will be understood all the more so in instances of this type where there is a second, third or fourth child whose prepared food needs to be cut in like manner—where, otherwise, a great deal of time would have to be spent in frustratingly trying to cut each child's food into bite size portions before the parent's own food becomes cold or loses its taste when standing around for the time such cuttings would take.

While there have been described what are considered to be preferred embodiments of the present invention, it will be readily appreciated by those skilled in the art that modifications can be made without departing from the scope of the teachings herein. Different shapes for the scissor blades could be had, for example, as well as different shapes for the carry case—with both being selected of differing material compositions and/or dimensions for example—but the teachings of having a travel food scissor consisting of a pair of scissors within a pocket or bag carryable case would continue to apply. For at least such reason, therefore, resort should be had to the claims appended hereto for a true understanding of the scope of the invention.

1. A travel food scissor for cutting of food prepared for a child comprising:
a pair of scissors having teeth serrations along at least one of the two opposing cutting edges thereof; and
a releasably openable closed carry case housing said scissors of a size to fit within a shirt or blouse pocket, a purse, handbag or pocketbook;
wherein said pair of scissors are of a metal composition; and
wherein said closed carry case is to be opened for the removal of said scissors substantially only at an eating establishment where plastic knives and forks are provided as cutting utensils for the food prepared for the child.

2. The travel food scissor of claim 1, with serrations along both of said opposing cutting edges of said pair of scissors.

3. The travel food scissor of claim 1, with said carry case being of a length not in excess of six inches.

4. The travel food scissor of claim 1, with said carry case being of a width not in excess of four inches.

5. The travel food scissor of claim 1, with said carry case being of a length not in excess of six inches and of a width not in excess of four inches.

6. The travel food scissor of claim 1 wherein said carry case is closed at one end and includes a flip-open cover at an opposite end thereof.

7. The travel food scissor of claim 6 wherein said closed end of said carry case is of a narrower width than at said opposite end.

8. The travel food scissor of claim 7 wherein said opposite end of said carry case includes a pair of first wall surfaces upwardly extending from an underlying lid to respectively join with a pair of second wall surfaces downwardly extending from said flip-open cover.

9. The travel food scissor of claim 7 wherein said opposite end of said carry case includes a pair of curved wall surfaces upwardly extending from an underlying lid to respectively join with a pair of straight wall surfaces downwardly extending from said flip-open cover.

10. The travel food scissor of claim 8 wherein said underlying lid includes an end extension of a rear surface of said carry case and wherein said flip-open cover comprises an overlying end extension of a front surface of said case.

11. The travel food scissor of claim 10 wherein said carry case is of a plastic composition.

12. The travel food scissor of claim 10 wherein said pair of scissors is of a stainless steel composition.

13. The travel food scissor of claim 10 wherein said flip-open cover is hinged to said front surface of said carry case.

14. The travel food scissor of claim 10 wherein said carry case is of a length, width and depth not to exceed six inches, four inches and one inch respectively.
